(19) United States
(12) Patent Application Publication
(10) Pub. No.: US 2004/0156412 A1
(43) Pub. Date: Aug. 12, 2004

(54) Driving device and light-emitting system for a laser diode

(76) Inventors: Yu-Hung Sun, Taipei City (TW); Chih-Hao Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/761,007

(22) Filed: Jan. 20, 2004

(30) Foreign Application Priority Data
Jan. 27, 2003 (TW) 92101679

(51) Int. Cl. H01S 3/00

(52) U.S. Cl. 372/50

(57) ABSTRACT

A laser diode driving device is disclosed. Sufficient driving current to a laser diode is maintained, even when the laser diode reaches high temperature. A laser diode light-emitting system utilizing the driving device is also disclosed. To reduce probability of the transistor entering the saturation region by parallel connecting a plurality of transistors and increasing stability of a laser diode driving circuit under high temperature.

### BACKGROUND OF THE INVENTION

1. Field of the Invention

The present invention relates to a driving device and in particular to a driving device for compensating a laser diode and a light-emitting system utilizing the driving device.

2. Description of the Related Art

Normally, brightness of a light emitted from a laser diode decays while the temperature grows. Thus a driving device of the laser diode must provide sufficient amount of driving current for the laser diode to maintain a fixed level of brightness. However, under a higher temperature with the required current, transistors of the driving circuit cannot function in an active region, such that the driving circuit cannot provide sufficient driving current for the laser diode.

FIG. 1 shows the circuit of a conventional driving device for a laser diode. The conventional driving circuit for a laser diode comprises a laser diode module 12, a driving module 11, a diode D, and a driving circuit 15. The laser diode module 12 emits light according to a driving current Ic and outputs a brightness signal MD according to the brightness of the emitted light. The driving module 11 outputs a driving signal LDO according to the brightness signal MD. The driving circuit 15 outputs the driving current Ic for the laser diode module 12 according to the driving signal LDO.

The laser diode module 12 comprises a laser diode 13, a photo-detector 14, and a load resistor RL. The photo-detector 14 generates the brightness signal MD according to brightness of the light emitted from the laser diode 13.

The driving circuit 15 comprises a PNP Bipolar Junction Transistor (hereafter as transistor) Q1, a current-limiting resistor R, and a capacitor C. The transistor Q1 outputs the driving current Ic according to the driving signal LDO. The current-limiting resistor R helps to generate an emitter voltage V_{E}. And the capacitor C is used to cancel noise.

When the brightness of the light emitted from the laser diode 13 decays due to the increasing temperature, the brightness signal MD detected by the photo-detector 14 also decreases. The driving module 11 compares the brightness signal MD with a preset value. The driving signal LDO is decreased when the brightness signal MD is less than the preset value. And the driving current Ic increases when the transistor Q1 is driven by a smaller driving signal LDO. Thus, a larger driving current is sent to the laser diode 13.

FIG. 2a shows characteristic curves illustrating the relation between driving current and temperature of a laser diode. As shown in the diagram, the laser diode requires more driving current as the temperature rises.

FIG. 2b shows characteristic curves illustrating the relation between collector current and emitter-collector saturation voltages of the transistor. As shown in the diagram, the saturation voltage V_{EC(sat)} of the transistor Q1 increases as the temperature rises.

The emitter current I_{E} and the collector current I_{C} will increase when the driving signal LDO decreases. And the emitter voltage V_{E} is obtained by:

V_{E}=V_{P}−I_{E}R;

wherein V_{P} is voltage source, I_{E} is the emitter current, and R is resistance of the current-limiting resistor. The emitter voltage V_{E} decreases as the emitter current I_{E} increases. The collector voltage V_{C} increases and the emitter-collector voltage V_{EC} decreases as the collector current I_{C} increases.

FIG. 3a is a schematic diagram of a transistor. FIG. 3b shows characteristic curves of the transistor. A is a saturation region, B is an active region, and C is a cut-off region. The transistor Q1 is in the saturation region A when the saturation voltage V_{EC(sat)} exceeds the emitter-collector voltage V_{EC}. The collector current I_{C} is not controlled by the base current I_{B} if the transistor Q1 is in the saturation region A. And then the transistor Q1 can not provide sufficient amount of the driving current for the laser diode 13 when the temperature rises.

Therefore, when the temperature rises, prior arts fail to maintain the transistor working in the active region B and are unable to increase the driving current of the laser diode effectively.

### SUMMARY OF THE INVENTION

It is therefore an object of the present invention to provide a laser diode light-emitting system reducing probability of the transistor entering the saturation region by parallel connecting a plurality of transistors and increasing stability of a laser diode driving circuit under high temperature.

According to the above mentioned object, the laser diode light-emitting system disclosed in the present invention comprises a laser diode module, a driving module, and a plurality of bipolar junction transistors. The laser diode module receives driving current, emits light, and outputs a brightness signal corresponding to the brightness of the light. The driving module changes a voltage level of driving signal according to voltage level of the brightness signal. The plurality of bipolar junction transistors are connected in parallel and coupled to a voltage source, providing the driving current to the laser diode module, wherein bases of the BJTs are coupled to the driving signal and wherein a value of the driving current is changed according to the voltage level of the driving signal.

When the bipolar junction transistors are PNP-type, the collector outputs the driving current to the laser diode module, and the emitter is coupled to the voltage source. The driving signal is directly proportional to the brightness signal and inversely proportional to the driving current.

When the bipolar junction transistors are NPN-type, the emitter outputs the driving current to the laser diode module, and the collector is coupled to the voltage source. The driving signal is inversely proportional to the brightness signal and directly proportional to the driving current.

Furthermore, the present invention provides a laser diode driving device outputting a driving current to a laser diode module, wherein when receiving the driving current, the laser diode module emits light and outputs a brightness signal corresponding to the brightness of the light. The laser diode driving device comprises a plurality of bipolar junction transistors and a driving module. The bipolar junction transistors are connected in parallel and coupled to a voltage source, providing the driving current to the laser diode module. The driving module changes a voltage level of a driving signal according to a voltage level of the brightness signal.

The present invention provides a laser diode driving circuit comprising a laser diode module, a driving module, and a plurality of current paths. The laser diode module receives a driving current to emit light and outputs a brightness signal corresponding to the brightness of the light. The driving module changes a voltage level of a driving signal according to a voltage level of the brightness signal. Each of the current paths is controlled by the driving signal, wherein a sum of currents on all current paths is the driving current, wherein the driving current is changed according to the voltage level of the driving signal, and wherein the current on each current path is in an active region.

### BRIEF DESCRIPTION OF THE DRAWINGS

The present invention can be more fully understood by reading the subsequent detailed description and examples with reference made to the accompanying drawings, wherein:

FIG. 1 shows a circuit of a conventional laser diode driving device;

FIG. 2a shows driving current to temperature characteristic curves of the laser diode;

FIG. 2b shows comparing I_{C} to V_{EC(sat)} characteristic curves of the transistor;

FIG. 3a is a schematic diagram of the transistor;

FIG. 3b shows V_{EC} to I_{C} characteristic curves of the transistor;

FIG. 4 is a circuit diagram of an embodiment according to the present invention;

FIG. 5 is a schematic diagram showing the working point of the transistor.

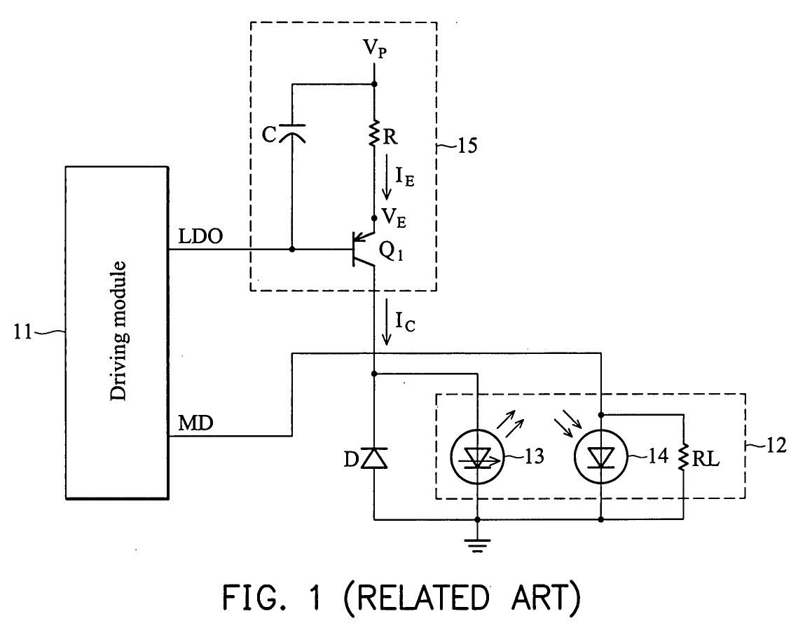

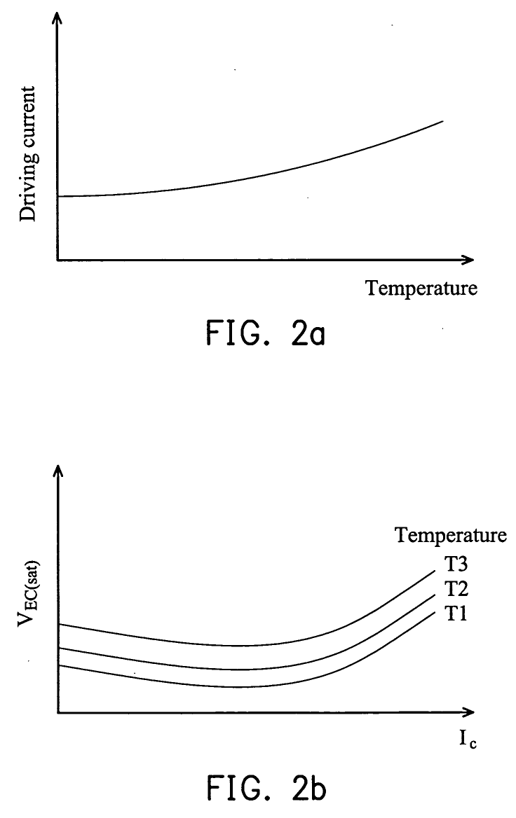

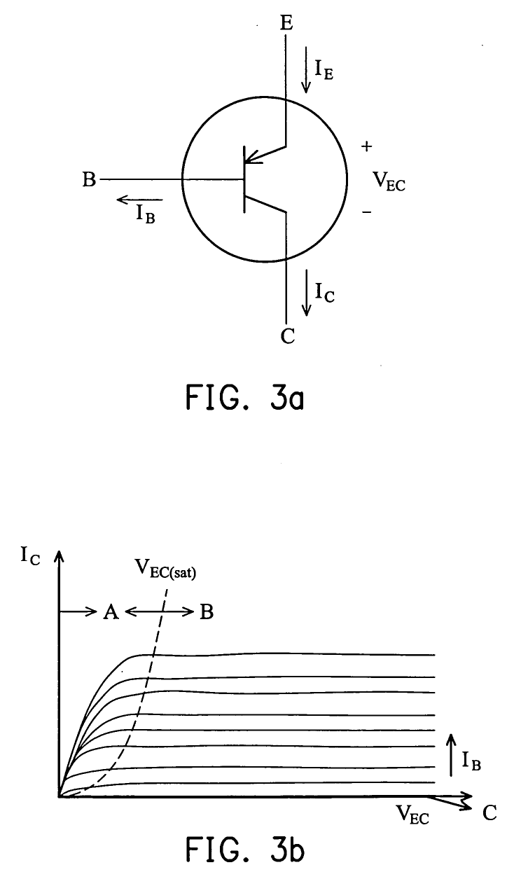

### DETAILED DESCRIPTION OF THE INVENTION

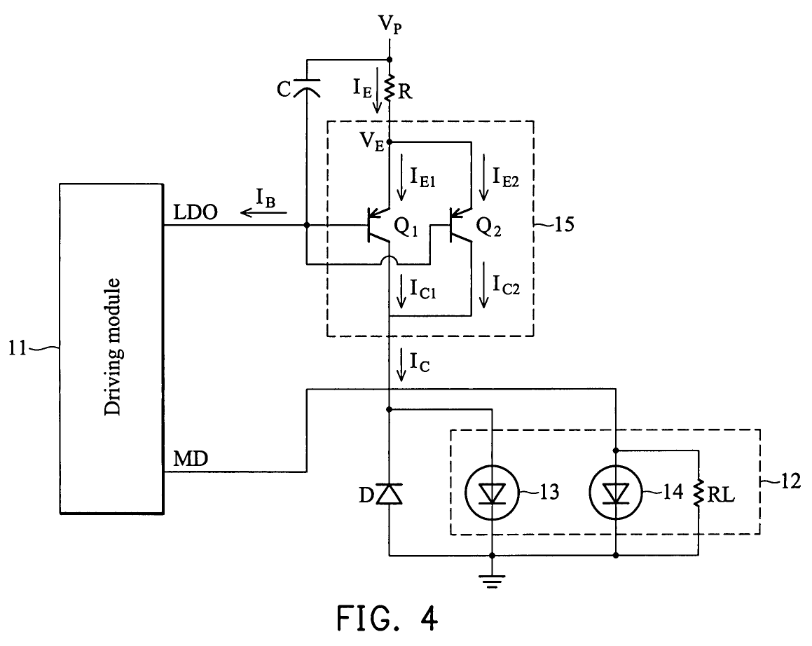

FIG. 4 is a circuit diagram of the embodiment according to the present invention. For the sake of illustrating the present invention concisely, parts that are similar or identical to those with regard to the prior art or conventional art are identified with the same reference numerals, and their explanations are omitted. As shown in the diagram, a laser diode light-emitting system comprises a laser diode module 12, a driving module 11, a current-limiting resistor R, a capacitor C, a diode D, and a plurality of current paths. The laser diode module 12 receives a driving current I_{C} to emit light and output a brightness signal MD corresponding to the brightness of the light. The driving module 11 changes a voltage level of a driving signal LDO according to a voltage level of the brightness signal MD. Each current path is controlled by the driving signal LDO. And a sum of the currents on all paths is the driving current, wherein the driving current is changed according to the voltage level of the driving signal LDO.

Each current path comprises a NPN-type bipolar junction transistor or a PNP-type bipolar junction transistor. In this embodiment, there are two PNP-type bipolar junction transistors Q1, Q2, connected in parallel and coupled to a voltage source V_{P}. These two transistors is used or providing the driving current I_{C} to the laser diode module 12. Bases of the transistors Q1, Q2 are coupled to the driving signal LDO, wherein a value of the driving current I_{C} is changed according to the voltage level of the driving signal LDO.

The current-limiting resistor R is coupled between the voltage source V_{P} and the emitters of the transistors Q1, Q2. The capacitor C is coupled between the voltage source V_{P} and the bases of the transistors Q1, Q2 for noise cancellation. The diode D is used to rectify the direction of current.

The laser diode module 12 comprises a laser diode 13, a photo-detector 14, and a load resistor RL. The photo-detector 14 detects the brightness of the light emitted from the laser diode 12. The load resistor RL transforms the detected brightness into a brightness signal MD.

In FIG. 4, the brightness of the light emitted from the laser diode 13 decays while the temperature grows. Therefore, the brightness signal MD detected by the photo-detector 14 is also decreased. The driving module 11 decreases the voltage of the driving signal LDO in order to increase the base current I_{B}, such that the driving current I_{C} is increased correspondingly. In the embodiment, the functions of the parallel connected transistors Q1 and Q2 are the same.

Accordingly, a total amount of the base current I_{B} is the sum of all the base currents of the transistors Q1 and Q2 (I_{B}=I_{B1}+I_{B2}). A total amount of the collector current I_{C} is the sum of the collector currents of the transistors Q1, Q2 (I_{C}=I_{C1}+I_{C2}). And a total amount of the emitter current I_{E} is the sum of the emitter currents of the transistors Q1, Q2 (I_{E}=I_{E1}+I_{E2}). Since the transistors Q1, Q2 are working under the same circumstance and have the same function and working point, current through each terminal of the transistors Q1 equals that of the transistors Q2.

Because the amount of total emitter current I_{E} equals (1+h_{FE})×I_{B}, the amount of total emitter current I_{E} and the amount of total collector current I_{C} are increased when the base current I_{B} increases. Furthermore, because the transistors Q1, Q2 are connected in parallel, the amount of total emitter current I_{E} is evenly distributed between the emitter current of the transistors Q1, Q2. Thus, even the amount of total emitter current I_{E} suddenly increases, the emitter currents I_{E1}, I_{E2} remain relatively stable.

Also the current at the collector of each transistor Q1, Q2 does not change rapidly. Thus the voltage between the emitter and the collector of each transistor remains stable and exceeding a saturation voltage V_{EC(sat)}. Therefore, each of the transistors is kept in an active region, whereby the driving current of the laser diode 13 can be under control.

The saturation voltage V_{EC(sat)} may increase as the temperature or the collector current increases. The present invention eases the increasing of the saturation voltage V_{EC(sat)}.

Moreover, when NPN-type bipolar junction transistors are used for the current paths, the emitters output the driving current to the laser diode module 12, the collectors are coupled to the voltage source V_{P}, and the bases are coupled to the driving signal. The driving signal is inversely proportional to the brightness signal and directly proportional to the driving current.

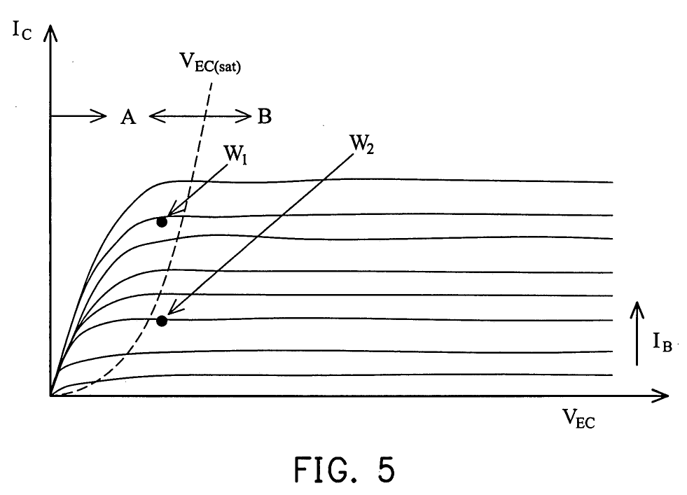

FIG. 5 is a collector currents to emitter-collector voltages schematic diagram showing the working point of the transistors. A is a saturation region and B is an active region. Point W₁ is the working point of the transistor in the prior art when higher collector current is needed. Utilizing the present invention decreases the collector current of each transistor and increases the voltage between emitter and collector of the transistor. Thus the working point is moved to the active region B as Point W₂ in the diagram.

The present invention reduces the probability of the transistor entering the saturation region. By parallel connecting transistors, collector current for each transistor is decreased such that the voltage between the emitter and collector of the transistor is less than saturation voltage V_{EC(sat)}. Additionally, the present invention changes the working point of the transistor from the saturation region to the active region.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A laser diode light-emitting system, comprising:
a laser diode module receiving a driving current to emit light and outputting a brightness signal corresponding to the brightness of the light;
a driving module changing a voltage level of a driving signal according to a voltage level of the brightness signal; and
a plurality of bipolar junction transistors (BJTs), connected in parallel and coupled to a voltage source, providing the driving current to the laser diode module, wherein bases of the BJTs are coupled to the driving signal and wherein a value of the driving current is changed according to the voltage level of the driving signal.

2. The laser diode light-emitting system as claimed in claim 1, wherein the BJT is a PNP-type transistor having a collector outputting the driving current to the laser diode module and an emitter coupled to the voltage source and wherein the driving signal is directly proportional to the brightness signal and inversely proportional to the driving current.

3. The laser diode light-emitting system as claimed in claim 1, wherein the BJT is a NPN-type transistor having an emitter outputting the driving current to the laser diode module and a collector coupled to the voltage source and wherein the driving signal is directly proportional to the brightness signal and inversely proportional to the driving current.

4. The laser diode light-emitting system as claimed in claim 1, wherein the laser diode module comprises:
a laser diode receiving the driving current to emit light; and
a photo-detector detecting the brightness of the light emitted from the laser diode to generate the brightness signal, wherein the brightness of the light emitted from the laser diode is directly proportional to the brightness signal.

5. A laser diode driving device outputting a driving current to a laser diode module, wherein when receiving the driving current, the laser diode module emits light and outputs a brightness signal corresponding to the brightness of the light, comprising:
a plurality of bipolar junction transistors (BJTs), connected in parallel and coupled to a voltage source, supplying the driving current to the laser diode module; and
a driving module changing a voltage level of a driving signal according to a voltage level of the brightness signal.

6. The driving device as claimed in claim 5, wherein the BJT is a PNP-type transistor having a collector outputting the driving current to the laser diode module and an emitter coupled to the voltage source and wherein the driving signal is directly proportional to the brightness signal and inversely proportional to the driving current.

7. The driving device as claimed in claim 5, wherein the BJT is a NPN-type transistor having an emitter outputting the driving current to the laser diode module and a collector coupled to the voltage source and wherein the driving signal is directly proportional to the brightness signal and inversely proportional to the driving current.

8. A laser diode driving circuit, comprising:
a laser diode module receiving a driving current to emit light and output a brightness signal corresponding to the brightness of the light;
a driving module changing a voltage level of a driving signal according to a voltage level of the brightness signal; and
a plurality of current paths, each of which is controlled by the driving signal, wherein an amount of total currents on all current paths is the driving current, wherein the driving current is changed according to the voltage level of the driving signal, and wherein the current on each current path is in an active region.

9. The driving circuit as claimed in claim 8, wherein each of the current paths is a PNP-type bipolar junction transistor with a collector coupled to the laser diode module, an emitter coupled to the voltage source, and a base coupled to the driving signal and wherein the driving signal is directly proportional to the brightness signal.

10. The driving circuit as claimed in claim 8, wherein each of the current paths is a NPN-type bipolar junction transistor with an emitter coupled to the laser diode module, a collector coupled to the voltage source, and a base coupled to the driving signal and wherein the driving signal is inversely proportional to the brightness signal.
